(19) United States
(12) Patent Application Publication
(10) Pub. No.: US 2009/0285929 A1
(43) Pub. Date: Nov. 19, 2009

(54) REDUCED THICKNESS INJECTION MOULDED PART DESIGN

(75) Inventors: George Diamantakos, Toronto (CA); Jeffrey Ngai, North York (CA); Jordan Bruce Robertston, Toronto (CA)

Correspondence Address: HARNESS, DICKEY & PIERCE, P.L.C., P.O. BOX 828, BLOOMFIELD HILLS, MI, 48303, US

(73) Assignee: STACKTECK SYSTEMS LIMITED, Brampton (CA)

(21) Appl. No.: 12/435,660

(22) Filed: May 5, 2009

(30) Foreign Application Priority Data
May 14, 2008 (CA) 2631762

(51) Int. Cl. B29C 45/18

(52) U.S. Cl. 425/542; 428/34.1

(57) ABSTRACT

An injection moulded part design which may be reflected in a part and the mould for making the part has a continuous alternating arrangement of thicker and thinner panels each extending from a gate area along a direction of flow to a transition line. Beyond the transition line the arrangement of thicker and thinner panels is inverted with the thicker panels continuing as thinner panels and vice versa along the direction of flow.

### FIELD OF THE INVENTION

The present invention relates to injection moulded plastic parts. More particularly, the invention relates to part designs utilizing thin wall sections for reduced material consumption.

### BACKGROUND OF THE INVENTION

There is an ongoing desire to make injection moulded parts such as containers, cups, closures, lids, pails, etc. with less material both to reduce weight and to reduce material cost. A challenge presented by thinner parts is in filling the mould. The thinner a part is configured the more pressure is required to force melt into the space defined between a mould core and a mould cavity.

A technique used in getting melt to zones in injection moulded parts that are difficult to fill in is the use of “flow leaders” which are in effect channels of greater thickness than the adjacent part to enhance material flow through a larger cross-sectional area of the flow leaders. Such an approach however doesn't work well with parts in which weight reduction through very thin walls is desired. As described in more detail below, once the disparity in flow rates between the thinner and thicker areas exceeds a certain amount poor part quality can ensue.

It is an object of the present invention to provide a part design which is injection mouldable yet of thin wall and lightweight configuration. It is a further object of the present invention to provide such part design which is conducive to parts having large flat surfaces.

### SUMMARY OF THE INVENTION

An injection moulded part design and a mould for malting the part has a continuous alternating arrangement of thicker and thinner panels each extending from a gate area along a direction of flow to a transition line. Beyond the transition line the arrangement of thicker and thinner panels is substantially inverted with the thicker panels continuing as thinner panels and vice versa along the direction of flow.

The transition line may extend transverse to the direction of flow uninterruptedly across a plurality of the thick and thin panels.

The transition line may correspond to a transition between a bottom of the part and a side wall of the part.

The part design may be arranged wherein the thicker sections do not transition into thinner sections in portions of the part where strength is paramount to thickness. Such portions may correspond to corners and edges.

The transition from thicker to thinner sections and vice versa may be offset.

The part may, without limitation, be a closure, container, cup, pail, bucket or a long flat part such as a lid or a tray.

### DESCRIPTION OF DRAWINGS

Preferred embodiments of the present invention are described below with reference to the accompanying illustrations in which:

FIG. 1 is a perspective view from above of an injection moulded part according to the present invention;

FIG. 2 is a pictorial representation illustrating flow front advancement as a function of time across the bottom of a part according to FIG. 1;

FIG. 3 is a pictorial representation illustrating flow front advancement as a function of time up the side wall of a part having thicker and thinner areas extending uninterrupted from a gate area across a bottom and up the wall of a container; and,

FIG. 4 is a pictorial representation illustrating flow front advancement as a function of time up the wall of a part according to the present invention.

### DETAILED DESCRIPTION OF PREFERRED EMBODIMENTS

An injection moulded part according to the present invention is generally indicated by reference 10 in the accompanying illustrations. The part 10 is illustrated as a container with a bottom 12 and a side wall 14. Other parts are however feasible including, without limitation containers, closures, cups, pails, buckets and long flat parts which have no side wall portion such as lids, trays, etc. All shapes such as round, oval, rectangular, etc. are also feasible.

The part 10 comprises a continuous surface defined by an alternating arrangement of thicker panels 20 and thinner panels 30. The thinner panels 20 and thicker panels 30 extend from a gate area 40 which corresponds to where melt initially enters a mould in which the part 10 is formed. Although gate area 40 is illustrated it will be appreciated that multiple gate areas are feasible depending on part configuration. The thicker panels 20 and thinner panels 30 may vary in thickness as required for strength and for fill pattern during forming.

The thinner panels 30 and thicker panels 40 extend from the gate area along a direction of flow which extends generally radially outwardly from the gate area 40. The term “direction of flow” refers to the direction in which melt flows through the mould in filling up the mould after being introduced into the gate area.

The thinner panels 30 and thicker panels 40 extend to a transition line 50 extending about the part 10 where the bottom 12 meets the side walls 14. Although such an arrangement is convenient for the part 10 illustrated, in other part configurations, such as large flat parts, the transition line 50 may be coplanar with the balance of the part 10. Although the transition line 50 is illustrated as a thin band, such need not be the case as it may have zero length. In other words, the thinner panels 30 may transition into the thicker panels 40 directly.

Beyond the transition line 50, the part 10 continues to be comprised of an arrangement of thicker panels 30 and thinner panels 40, however the arrangement is generally inverted from what it is on the opposite side of the transition line 50. While the inversion could be total, in the part illustrated this isn't the case in its corners 16 and side edges 18 as it is expected that the benefit of greater thickness in these areas will structurally enhance the part 10 to an extent that exceeds the benefit of reducing the weight of the part by thinning these areas. A further benefit of the “non-inversion” is that the thicker portions act as true flow leaders to help fill the corners.

Although the illustrations depict the thicker panels 40 as directly opposite the thinner panels 30 they do not have to align exactly as general or substantial alignment may suffice. Also there may be more than one transition line 50 spaced apart on the part 10 as required to control flow.

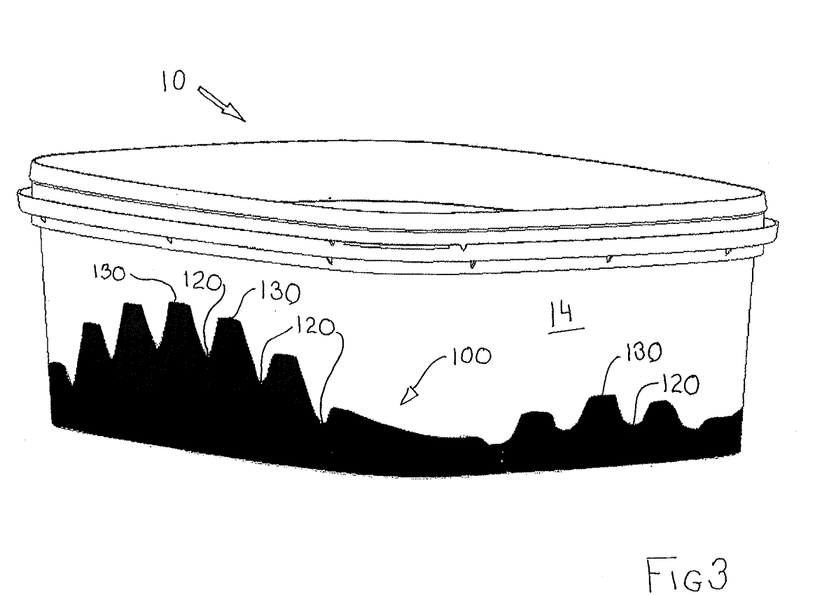

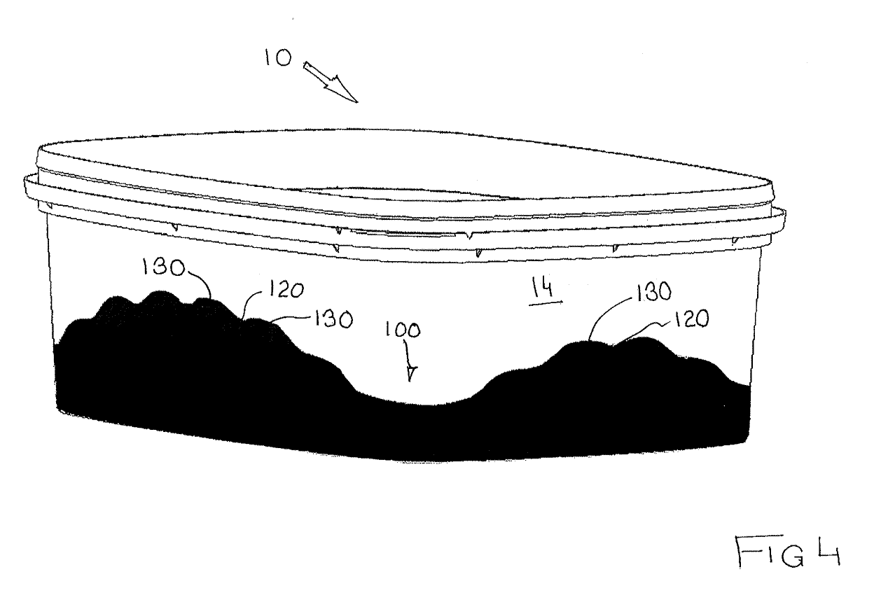

The benefit of the present invention may be seen by comparing the flow front advancement as illustrated in FIG. 3 depicting a part 60 lacking a transition line where the thicker panels 40 align with the thicker panels 40 and the thinner panels 30 align with the thinner panels 30 with FIG. 4 depicting a part according to the present invention having a transition line 50.

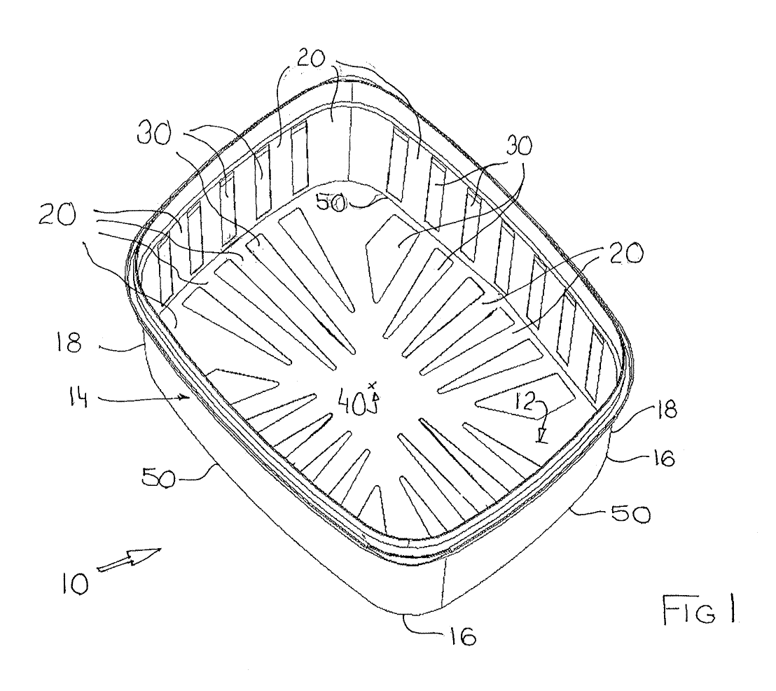

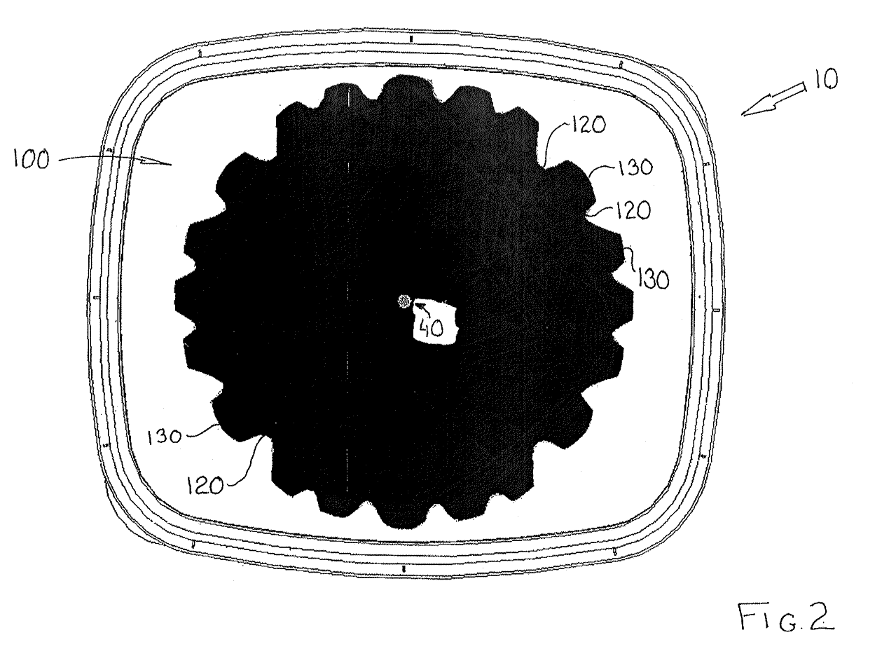

Reference is first made to FIG. 2 which illustrates the distribution of melt shortly after injection in a part 10 having a bottom configuration according to the part 10 of FIG. 1. The leading edge of the melt, known as its “flow front” is depicted by reference 100.

Reference 120 depicts the flow front 100 in the regions of the thinner panels 20. Reference 130 depicts the flow front 100 in the region of the thicker panels 30. It is apparent that the rate of advancement of the melt is greater in the regions of the thicker panels 30 as the flow front 100 is further advanced in the regions 130 than it is in the regions 120.

Reference is now made to FIG. 3 which illustrates the flow front 100 later in the injection cycle for a part 60 having a thicker areas 63 and thinner areas 62. The flow front 100 is significantly advanced in the regions 130 which correspond to the thicker areas 63 as compared with the regions 120 corresponding to the thinner regions 62.

Reference is now made to FIG. 4 which illustrates the flow front 100 as it advances along the side wall 14 of the part 10. As compared to the flow front 100 in FIG. 3 the flow front 100 in FIG. 4 is much more even without pronounced peaks and valleys as is the case with the FIG. 3 arrangement. The flow front 100 of the FIG. 4 arrangement is significantly better for forming a part 10 of good quality avoiding the possibility of trapping air/gas within the part 10 as the flow front 100 wraps around.

It will be appreciated that the part design of the part 10 of the present invention relates back to the mould design. Accordingly the present invention extends to mould design as well as the resulting part.

The above invention is described in an illustrative rather than a restrictive sense. Variations may be apparent to persons skilled in such arrangements without departing from the spirit and scope of the invention as defined by the claims set out below.

1. An injection moulded part comprising a continuous, alternating arrangement of thicker and thinner panels each extending from a gate area along a direction of flow to a transition line beyond which said arrangement of thicker and said thinner panels is generally inverted with said thicker panels substantially continuing as thinner panels and vice versa along said direction of flow.

2. The injection moulded part of claim 1 wherein said transition line extends transverse to said direction of flow and uninterrupted across a plurality of said thick and said thin panels.

3. The injection moulded part of claim 2 wherein said transition line corresponds to a transition between a bottom of said part and a side wall of said part.

4. The injection moulded part of claim 3 wherein said thicker sections do not transition into thinner sections in portions of said part where strength is paramount to thinness.

5. The injection moulded part of claim 4 wherein said portions are corners and edges.

6. The injection moulded part of claim 2 wherein said transition line is a band.

7. The injection moulded part of claim 5 wherein said part is a member selected from the group consisting of closure, container, cup, pail and bucket.

8. The injection moulded part of claim 2 wherein said part is a long flat part.

9. The injection moulded part of claim 8 wherein said part is a member selected from the group consisting of lid and tray.

10. The injection moulded part of claim 1 having multiple of said transition lines spaced apart thereon.

11. An injection mould comprising a core and a cavity defining between them, in a closed configuration, a continuous alternating arrangement of thicker and thinner panels each extending from a gate area along a direction of flow to a transition line beyond which said arrangement of thicker and said thinner panels is generally inverted with said thicker panels substantially continuing as thinner panels and vice versa along said direction of flow.

12. The injection mould of claim 11 wherein said transition line extends transverse to said direction of flow and uninterrupted across a plurality of said thick and said thin panels.

13. The injection mould of claim 12 wherein said transition line corresponds to a transition between a bottom of said part and a side wall of said part.

14. The injection mould of claim 13 wherein said thicker sections do not transition into thinner sections in portions of said part where strength is paramount to thinness.

15. The injection mould of claim 14 wherein said portions are corners and edges.

16. The injection mould of claim 12 wherein said transition line is a band.

17. The injection mould of claim 15 wherein said part is a member selected from the group consisting of closure, container, cup, pail and bucket.

18. The injection mould of claim 13 wherein said part is a long flat part.

19. The injection mould of claim 18 wherein said part is a member selected from the group consisting of lid and tray.

20. The injection mould of claim 12 having multiple of said transition lines spaced apart thereon.
